(19) United States
(12) Patent Application Publication
(10) Pub. No.: US 2020/0132560 A1
(43) Pub. Date: Apr. 30, 2020

(54) HIGH-RESOLUTION TEMPERATURE SENSOR BASED ON BUILT-IN SAC AND SPECTRAL-VALLEY-POINT ANALYSIS

(71) Applicant: Shenzhen University, Shenzhen, Guangdong (CN)

(72) Inventors: Zhengbiao Ouyang, Shenzhen (CN); Zhiliang Chen, Shenzhen (CN)

(21) Appl. No.: 16/485,051

(22) PCT Filed: Nov. 21, 2016
(86) PCT No.: PCT/CN2016/106683

§ 371 Date: Aug. 9, 2019

Related U.S. Application Data
(63) Continuation of application No. PCT/CN2016/106683, filed on Nov. 21, 2016.

(30) Foreign Application Priority Data
Feb. 15, 2016 (CN) 201610086299.6

(51) Int. Cl. G01K 11/32; G01K 5/14

(52) U.S. Cl. CPC G01K 11/32; G01K 5/14

(57) ABSTRACT

A high-resolution temperature sensor based on a built-in sac and a spectral valley-point-method includes a built-in sac, a metal block, two waveguides, two metal films and a signal light; the built-in sac is connected with a first waveguide; the metal block is disposed in the first waveguide, and is movable; the first waveguide is connected with a second waveguide; and the signal light is broadband light or the frequency-sweeping light.

### CROSS-REFERENCE TO RELATED APPLICATIONS

This application is a Continuation of Application No. PCT/CN2016/106683, filed on Nov. 21, 2016, and claims priority to Chinese Patent Application No.201610086299.6, filed on Feb. 15, 2016. The entire contents of which are hereby incorporated by reference.

### TECHNICAL FIELD

The present disclosure is related to a high-resolution temperature sensor based on a built-in sac and a spectral-valley-point analysis.

### BACKGROUND

Temperature sensors are one of the most widely used sensors in the real world. From the thermometers in our lives, to thermometers in large instruments and temperature control devices in integrated circuits, temperature sensors are everywhere. Traditional temperature sensors, such as thermal resistors, platinum resistors, and bimetal switches, have their own advantages, but are no longer suitable for use in miniature and high precision products. Semiconductor temperature sensors have high sensitivity, high resolution, low power consumption, and strong anti-interference ability, making them widely used in semiconductor integrated circuits.

The waveguide based on surface plasmon polariton (SPP) can break through the diffraction limit and realize optical information processing and transmission on the nanometer scale. Surface plasmon polaritons (SPPs) are surface electromagnetic waves that propagate on the surface of a metal when an electromagnetic wave is incident on the interface between the metal and a medium. In accordance with the nature of the surface SPPs, many devices based on simple SPP structures have been proposed, such as filters, circulators, logic gates, and optical switches. These devices are relatively simple in structure and very convenient for optical circuit integration.

### SUMMARY

The purpose of the present disclosure is to overcome the deficiencies in the prior art and provide a high-resolution temperature sensor with an easily integrated metal-insulator-metal (MIM) structure.

In order to achieve the above object, the present disclosure adopts the following design scheme:

The disclosure, a high-resolution temperature sensor based on a built-in sac and a spectral-valley-point surface analysis includes a built-in sac, a metal block, two waveguides, two metal films and a signal light; the built-in sac is connected with a first waveguide; the metal block is disposed in the first waveguide, and is movable; the first waveguide is connected with a second waveguide; and the signal light is a broadband light or a frequency-sweeping light.

Inside the built-in sac is a high thermal-expansion-coefficient material.

Inside the built-in sac is ethanol, or mercury.

A shape of cross-sectional of the built-in sac is a rectangular, a circular, a polygonal, or an elliptical.

The metal block is gold, or silver; and the metal block is silver.

The first waveguide and the second waveguide are waveguides of a metal-insulator-metal (MIM) structure.

A medium in the second waveguide is air.

The signal light is a spectral signal in a wavelength range of 700 nm to 1000 nm.

The beneficial effects of the present invention compared with the prior art are:

The temperature sensor is compact in structure, small in size, and is very easy to integrate. The sensitivity of the temperature sensor reaches −274nm/° C. and the response time is in the microsecond range.

These and other objects and advantages of the present disclosure will become readily apparent to those skilled in the art upon reading the following detailed description and claims and by referring to the accompanying drawings.

### DETAILED DESCRIPTION OF THE DRAWINGS

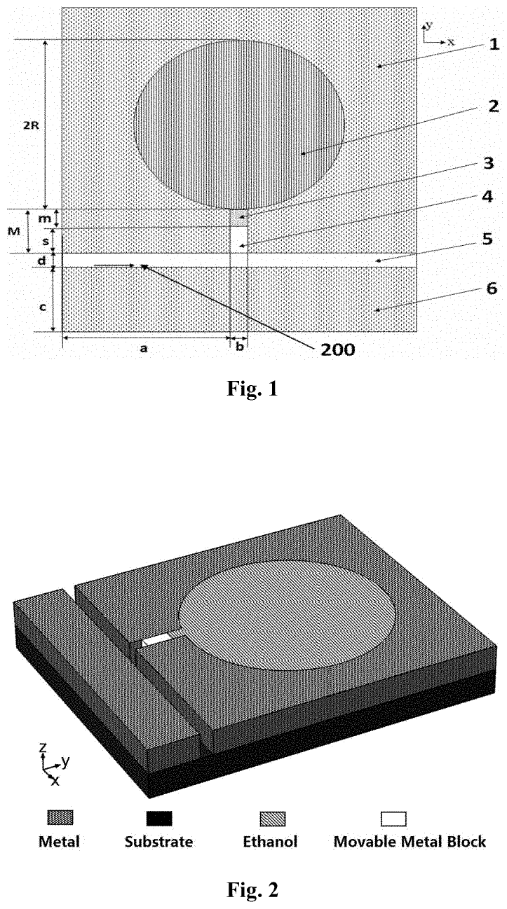

FIG. 1 is a schematic diagram of a two-dimensional structure of a high-resolution temperature sensor in at least embodiment 1.

FIG. 2 is a schematic view of the three-dimensional structure shown in FIG. 1

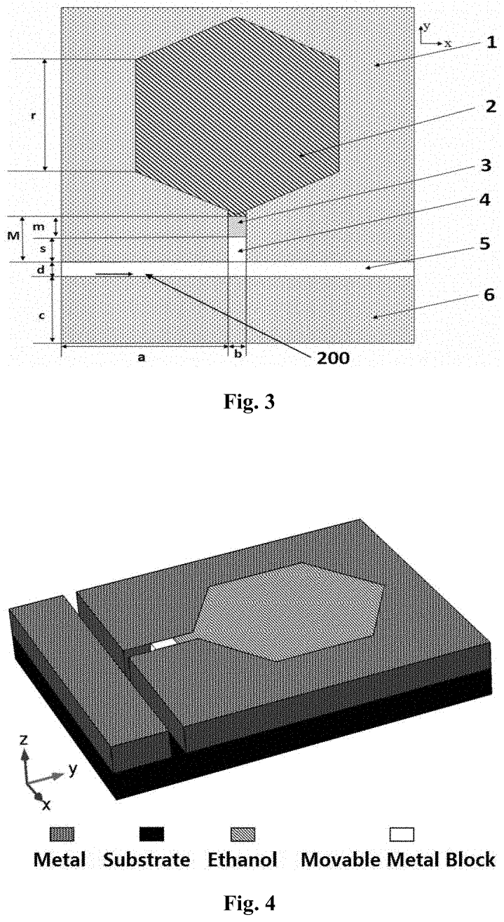

FIG. 3 is a schematic diagram of a two-dimensional structure of the high-resolution temperature sensor in at least embodiment 2.

FIG. 4 is a schematic diagram of the three-dimensional structure shown in FIG. 3.

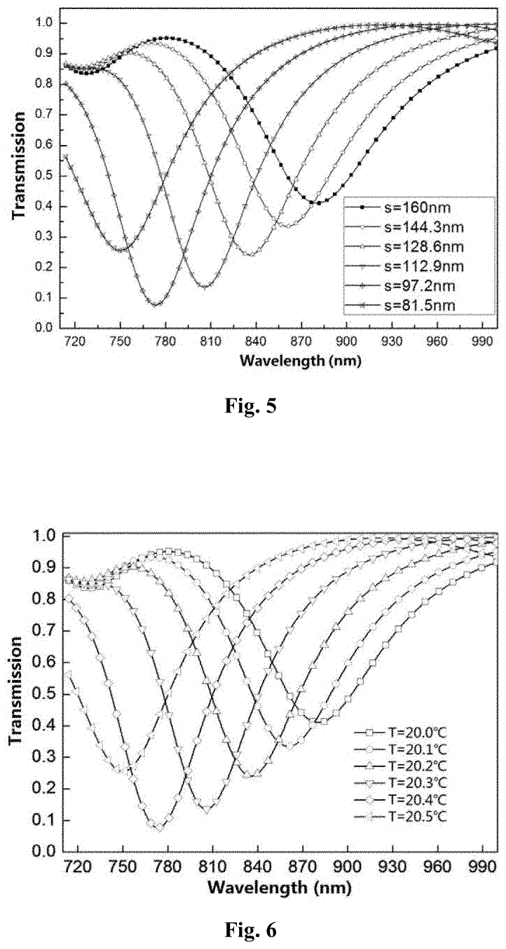

FIG. 5 is a transmission spectrum diagram of signal light with different wavelength.

FIG. 6 is a plot of the transmission spectrum versus temperature.

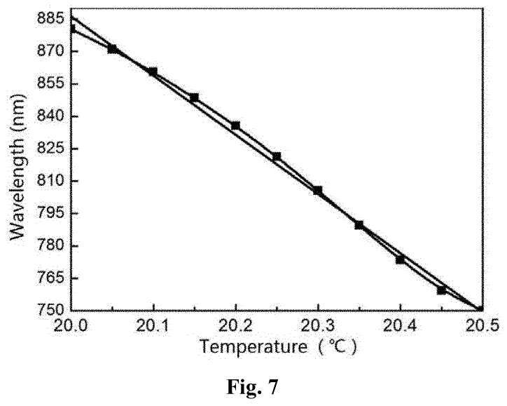

FIG. 7 is a graph of the relationship between the wavelength and temperature.

The present disclosure is more specifically described in the following paragraphs by reference to the drawings attached only by way of example.

### DETAILED DESCRIPTION

The terms a or an, as used herein, are defined as one or more than one, the term plurality, as used herein, is defined as two or more than two, and the term another, as used herein, is defined as at least a second or more.

As shown in FIGS. 1 and 2 (the packaging medium above the structure is omitted in FIG. 2), the present application is based on a high-resolution temperature sensor with a built-in sac and a spectral-valley-point analysis includes a metal film 1 (not etched), a built-in sac (or a temperature sensitive cavity) 2, a metal block (or a movable metal block) 3, a first waveguide (or a vertical waveguide) 4, a second waveguide (or a horizontal waveguide) 5, a metal films 6 (not etched), and a signal light (or a horizontally propagating signal light) 200, it propagates along the waveguide surface and forms the surface plasmon polaritons (SPPs); signal light 200 uses broadband light or frequency-swept light; the built-in sac 2 is connected with the first waveguide 4, and the built-in sac 2 has a circular cavity in cross section with a radius of R, the cross-sectional area of the built-in sac 2 is 502655 nm² and the thickness is 1 μm. The material inside the built-in sac 2 has a low specific heat capacity with a high coefficient of expansion; the high thermal-expansion-coefficient material in the built-in sac 2 is ethanol, or mercury, preferably ethanol; the metal films 1 and 6 are gold, or silver, preferably silver, the thickness of the metals film 1 and 6 is h₁, and the range of thickness h₁ is greater than 100 nm, a thickness h₁ of the metal films 1 and 6 are respectively 100 nm; the thickness of the built-in sac 2 is greater than the thickness h₁ of the metal films 1 and 6; a metal block 3 is set within the first waveguide 4, and is movable, the length m of the metal block 3 is 125 nm, and the range of m is 80 to 150 nm; the space length between the metal block 3 and the second waveguide 5 is s, and the range of s is 0 to 200 nm, and is determined by the position of the metal block 3; the metal block 3 is gold, or silver, preferably silver; the first waveguide 4 is connected with the second waveguide 5, and the first waveguide 4 and the second waveguide 5 are waveguides of a metal-insulator-metal (MIM) structure; the insulator is made of a non-conductive transparent material, and is air, silicon dioxide, or silicon (Si); the first waveguide 4 is located at the upper end of the second waveguide 5, the width b of the first waveguide 4 is 35 nm, and the range of b is 30 to 60 nm, the length M of the first waveguide 4 is 300 nm, and M is over 200 nm; the distance a from the left edge of the first waveguide 4 to the left edge of the metal film 6 is 400 nm, and the range of a is 350 to 450 nm; the medium in the second waveguide 5 is air, the width d of the second waveguide 5 is 50 nm, and the range of d is 30 to 100 nm; the distance from the lower edge of the second waveguide 5 to the edge of the metal film 6 is c, and c is greater than 150 nm.

The present disclosure changes the volume of ethanol by a change in temperature, causing the ethanol to expand and push the metal block 3 to move toward the second waveguide 5 to change the length of the air segment in the first waveguide 4, and the metal block 3 moves downward so that the length of the second waveguide 5 changes, and the transmittance of the signal light 200 (i.e., the light signal) changes accordingly. Since the movement of the metal block 3 is controlled by the temperature, the temperature change affects the position of the transmission spectrum valley of the signal light 200, and the temperature change is obtained in accordance with the movement of the transmission spectrum valley. When the temperature drops back to its initial value, under the action of the external atmospheric pressure, the metal block 3 will return to its initial pressure-balanced position, which is convenient for the next detection.

The volume expansion coefficient of ethanol in the built-in sac 2 of the present disclosure is αₑₜₕₐₙₒₗ=1.1×10⁻³/° C., and the density of ethanol at room temperature (20° C.) is ρ=0.789 g/cm³. The linear expansion coefficient of metal block 3 is α_{Ag}=19.5×10⁻⁶/° C. Compared to the expansion of ethanol, the expansion of the metal block 3 is negligible at the same temperature change. Therefore, in the present disclosure, the influence of temperature changes on the volume of the metal block 3 is no longer considered. In accordance with the volume of the built-in sac 2 and the cross-sectional area of the metal block 3, the relationship between the position change of the metal block 3 and the temperature is calculated, thereby defining a proportional coefficient σ indicating the moving distance of the metal block 3 corresponding to the change of unit temperature:

$$σ = \frac{h \times S \times {α}_{ethanol}}{b \times {h}_{1}} . \qquad ( 1 )$$

This formula is also be used as a measure of the temperature sensitivity of the structure. According to this formula, it is concluded that the cross-sectional area of the circular built-in sac and the width of the metal block 3 have a relatively large influence on the positional change of the metal block 3. Comprehensively S=502655 nm² and b=35 nm are considered, obtaining σ=157 nm/° C., and the result is the relationship between the amount of movement of the metal block 3 and the temperature.

As shown in FIGS. 3 and 4 (the packaging medium above the structure is omitted in FIG. 4), the present disclosure is based on a high-resolution temperature sensor with a built-in sac and a spectral-valley-point analysis includes a metal film 1 (not been etched), a built-in sac (or a temperature sensitive cavity) 2, a metal block (or a movable metal block) 3, a first waveguide (or a vertical waveguide) 4, a second waveguide (or a horizontal waveguide) 5, a metal film 6 (not etched), and a signal light (or a horizontally propagating signal light) 200, it propagates along the waveguide surface and forms the surface plasmon polaritons (SPPs); signal light 200 uses broadband light or frequency-sweeping light; the built-in sac 2 is connected with the first waveguide 4, and the cross-sectional area of the built-in sac 2 is a hexagonal cavity, the side length is r, and the cross-sectional area of the built-in sac 2 is 502655 nm² and the thickness of the built-in sac 2 is 1 μm. The material inside the built-in sac 2 has a low specific heat capacity with a high coefficient of thermal expansion; the high thermal-expansion-coefficient material in the built-in sac 2 is ethanol, or mercury, preferably ethanol; the metal films 1 and 6 are gold, or silver, preferably silver, a thickness of the metal films 1 and 6 is h₁, the range of thickness h₁ is greater than 100 nm, and the thickness hi of the metal films 1 and 6 are respectively 100 nm; the thickness hi of the built-in sac 2 is greater than the thickness h₁ of the metal films 1 and 6; metal block 3 is set within the first waveguide 4, and is movable, the length m of the metal block 3 is 125 nm, and the range of m is 80 nm to 150 nm; the space length between the metal block 3 and the second waveguide 5 is s, and the range of s is 0 to 200 nm, and is determined by the position of the metal block 3; the metal block 3 is gold, or silver, preferably silver; the first waveguide 4 is connected with the second waveguide 5, and the first waveguide 4 and the second waveguide 5 are waveguides of a metal-insulator-metal (MIM) structure; the insulator is made of a non-conductive transparent material, and is air, silicon dioxide, or silicon; the first waveguide 4 is located at the upper end of the second waveguide 5; the width b of the first waveguide 4 is 35 nm, and the range of b is 30 to 60 nm; the length M of the first waveguide 4 is 300 nm, and M is over 200 nm; the distance a from the left edge of the first waveguide 4 to the left edge of the metal film 6 is 400 nm, and the range of a is 350 to 450 nm; the medium in the second waveguide 5 is air, the width d of the second waveguide 5 is 50 nm, and the range of d is 30 to 100 nm; the distance from the lower edge of the second waveguide 5 to the edge of the metal film 6 is c, and c is greater than 150 nm.

In the present disclosure, the volume of ethanol is changed by temperature, causing the ethanol to expand and push the metal block 3 to move toward the second waveguide 5 to change the length of the air segment in the first waveguide 4, and the metal block 3 moves downward, so that the length of the second waveguide 5 changes, and the transmittance of the signal light 200 (i.e., the light signal) changes accordingly. Since the movement of the metal block 3 is controlled by the temperature, the temperature change affects the position of the transmission spectrum valley of the signal light 200, and the temperature change is obtained in accordance with the movement of the transmission spectrum valley. When the temperature drops back to its initial value, under the action of the external atmospheric pressure, the metal block 3 will return to its initial pressure-balanced position, which is convenient for the next detection.

The metal block 3 is moved downward to change the space length between the metal block 3 and the second waveguide 5, and the transmittance of the signal light 200 changes accordingly. FIG. 5 shows the transmittance of light at wavelength in the range of 700 nm to 1000 nm, for different value of s. The initial position of the metal block 3 is the position at the initial temperature, for example, 20° C., and the value of the metal block 3 is s=160 nm. It can be seen from the figure that the wavelength position of the valley point of the second waveguide 5 transmittance varies with the wavelength of s, and moves gradually to the long wavelength region as s reduces. Since the position of the metal block 3 changes is related to the temperature due to the thermal expansion of ethanol, as the temperature in the ethanol zone increases by 1° C., the position of the metal block 3 moves downward by 157 nm. The downward movement of the metal block 3 changes the length s between the metal block 3 and the second waveguide 5, and finally the transmittance of the second waveguide 5 also changes. The amount of movement of the metal block 3 caused by unit change amount of temperature coincides with the scan step. Therefore, the change of light transmittance in the second waveguide 5 caused by the change of the length s of the second waveguide 5 is indirectly expressed by the temperature change. Then the amount of s in the result of FIG. 5 can be replaced with temperature, and the result is shown in FIG. 6. It is seen from FIG. 6 that the change rule of light transmittance in the second waveguide 5 caused by the change of s due to the change of the temperature T is consistent with FIG. 5. In addition, from FIG. 5 it is seen that the amount of shift in the wavelength of the valley point of light transmittance in the second waveguide 5 is very large for every temperature change of 0.1° C. Therefore, in accordance with the spectral characteristics of the output light of the second waveguide 5, the temperature changes can be known. After a fine scan, the wavelength corresponding to the transmittance valley point is obtained for each temperature point, and the relationship is shown in FIG. 7. The square-dotted black line in the figure shows the data points obtained by simulation, while the black solid line is the fitting curve from the simulation data. The sensitivity of the temperature sensor can be expressed as dλ/dT. The sensitivity data of the temperature sensor obtained from the simulation in FIG. 7 varies greatly and is in a state of fluctuation. This does not well represent the performance of the temperature sensor, so a straight line is obtained by performing interpolation fitting on the original data. In accordance with the expression of the sensitivity of the temperature sensor, the sensitivity of the temperature sensor for the present disclosure can be expressed as the slope of the black solid-line curve (i.e., dλ/dT=−274 nm/° C.). In addition, increasing the volume of the ethanol chamber, the sensitivity of the metal block 3 to temperature will increase, and the sensitivity of the temperature sensor will increase accordingly.

While the disclosure has been described in terms of various specific embodiments, those skilled in the art will recognize that the disclosure is practiced with modification within the spirit and scope of the claims.

What is claimed is:

1. A high-resolution temperature sensor based on a built-in sac and a spectral-valley-point analysis, comprising:
a built-in sac, a metal block, two waveguides, two metal films and a signal light; the built-in sac is connected with a first waveguide; the metal block is disposed in the first waveguide, and is movable; the first waveguide is connected with a second waveguide; and the signal light is a broadband light or a frequency-sweeping light.

2. The high-resolution temperature sensor based on a built-in sac and a spectral-valley-point analysis according to claim 1, wherein inside the built-in sac is a high thermal-expansion-coefficient material.

3. The high-resolution temperature sensor based on a built-in sac and a spectral-valley-point analysis according to claim 1, wherein inside the built-in sac is ethanol, or mercury.

4. The high-resolution temperature sensor based on a built-in sac and a spectral-valley-point analysis according to claim 1, wherein a shape of cross-sectional of the built-in sac is a rectangular, a circular, a polygonal, or an elliptical.

5. The high-resolution temperature sensor based on a built-in sac and a spectral-valley-point analysis according to claim 1, wherein the metal block is gold, or silver.

6. The high-resolution temperature sensor based on a built-in sac and a spectral-valley-point analysis according to claim 5, wherein the metal block is silver.

7. The high-resolution temperature sensor based on a built-in sac and a spectral-valley-point analysis according to claim 1, wherein the first waveguide and the second waveguide are waveguides of a metal-insulator-metal (MIM) structure.

8. The high-resolution temperature sensor based on a built-in sac and a spectral-valley-point analysis according to claim 1, wherein a medium in the second waveguide is air.

9. The high-resolution temperature sensor based on a built-in sac and a spectral-valley-point analysis according to claim 1, wherein the signal light is a spectral signal in a wavelength range of 700 to 1000 nm.
